(19) United States
(12) Patent Application Publication
(10) Pub. No.: US 2010/0095879 A1
(43) Pub. Date: Apr. 22, 2010

(54) Pressure Display Device For Compressors

(75) Inventors: Yung-yung Sun, Dali (TW); Chuan-Ching Cheng, Taiping (TW)

Correspondence Address: Wang Law Firm, Inc., 4989 Peachtree Parkway,, Suite 200, Norcross, GA, 30092, US

(73) Assignee: Storm Pneumtic Co. Ltd., Dali (TW)

(21) Appl. No.: 12/253,948

(22) Filed: Oct. 18, 2008

(51) Int. Cl. G01D 13/00

(52) U.S. Cl. 116/266

(57) ABSTRACT

A pressure display device includes a body having an adjustment valve and a display unit connected thereto. The pressurized air enters into the body via paths and the display unit. The pressure detection member detects the pressure and displays the value of the pressure in the display screen. The display screen can be adjusted its position relative to the body by rotating the rotary part such that the user can check value easily.

### FIELD OF THE INVENTION

The present invention relates to a pressure display device for compressors and more particularly, to a pressure display device whose display screen can be pivoted to desired direction.

### BACKGROUND OF THE INVENTION

A conventional compressor provides high pressure air to drive mechanical parts and is used widely in related industrial areas. In order to maintain a stable pressure, a three-point adjustment device is usually used in the compressor so as to regulate the output pressure.

The conventional pressure adjustment device generally includes a display screen so as to display the value of the pressure and the display screen is usually fixed to the compressor. The assemblers have to install the display screen to the hydraulic tools according to the angle of view from the users and the space that is allowed for the display screen. Therefore, the display screen may not be installed to meet the angle of view from the users, this restricts the assembly processes.

Furthermore, the hydraulic tool is connected with the compressor by a hose and does not have its own pressure display screen. If the hydraulic tool is equipped with the pressure display screen, a specific requirement has to be concerned which is that the hydraulic tool is held and operated at different angles according to the practical need so that how to install the pressure display screen on the hydraulic tool and allow the pressure display screen to be adjusted to meet the angle of view of the users is a break-through for the design of hydraulic tools.

The present invention intends to provide a pressure display device having a display screen and the pressure display device can be installed to the machine and the display screen can be adjusted to desired direction as needed.

### SUMMARY OF THE INVENTION

The present invention relates to a pressure display device which comprises a body having an adjustment valve connected thereto, and an inlet path and an outlet path are defined in the body. An adjustment path is defined in communication between the inlet path and the outlet path. A communication path is defined in communication between the outlet path and the adjustment path. The display unit includes a pressure detection member and a rotary part which is connected to the body. The pressure detection member is located in a space which is sealed and defined between the body and the rotary part. The space communicates with the communication path. A display screen is located on the rotary part and electrically connected to the pressure detection member. The display screen is rotated by rotating the rotary part.

The primary object of the present invention is to provide a pressure display unit wherein the display screen can be adjusted toward the users so that the user can convenient check the value of the pressure. The installation of the pressure display unit of the present invention is not restricted as described for the conventional pressure display screen and the pressure display unit of the present invention can be adjusted according the need of the users. The pressure display unit of the present invention is easily installed and conveniently operated.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the pressure display device of the present invention;

FIG. 2 is an exploded view to show the pressure display device of the present invention;

FIG. 3 is a cross sectional view taken along line 3-3 in FIG. 1;

FIG. 4 is a cross sectional view taken along line 4-4 in FIG. 1;

FIG. 5 is a perspective view to show that the pressure display device of the present invention is installed on machine “A”;

FIG. 6 is a perspective view to show that the pressure display device of the present invention is installed on machine “B”, and

FIG. 7 is a perspective view to show that the pressure display device of the present invention is installed on machine “C”.

### DETAILED DESCRIPTION OF THE PREFERRED EMBODIMENT

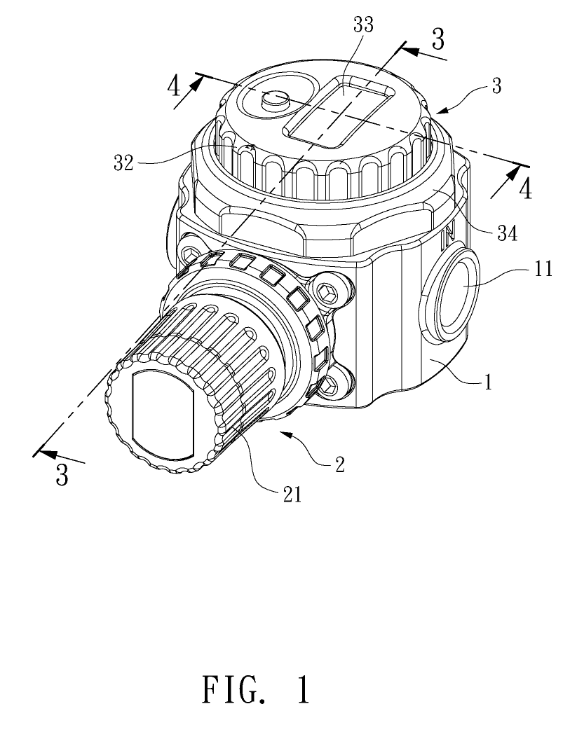

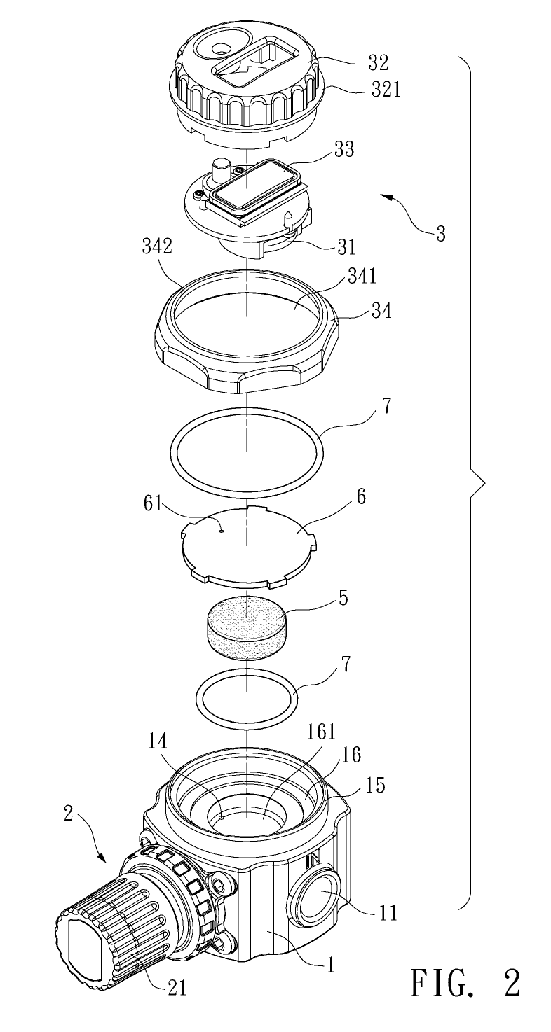

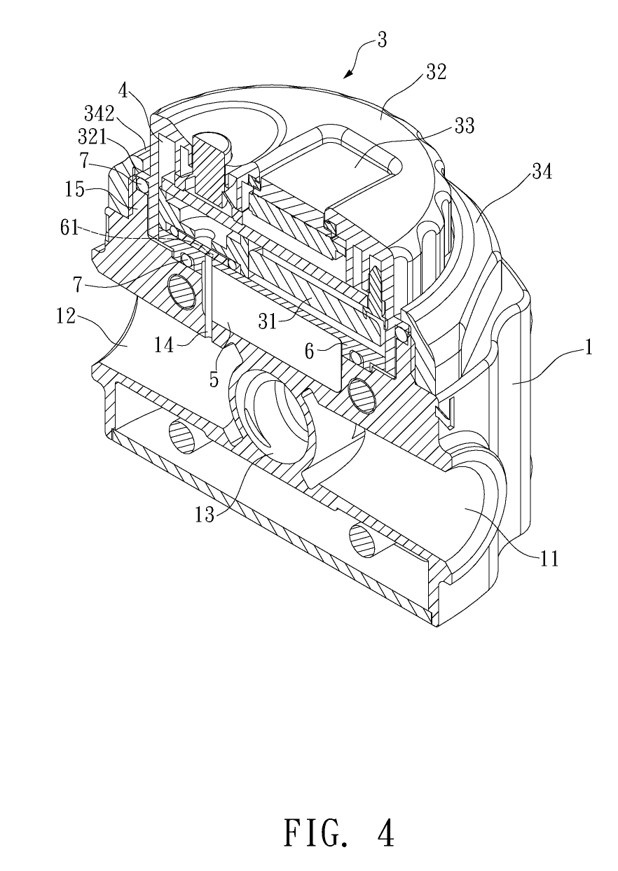

Referring to FIGS. 1 to 4, the pressure display device of the present invention comprises a body 1 which has an adjustment valve 2 and a display unit 3 connected thereto. The body 1 includes an inlet path 11 and an outlet path 12 defined in the body 1, the pressurized air is introduced into the body 1 via the inlet path 11 and the pressurized air is regulated and adjusted by the adjustment valve 2 and output from the outlet path 12 which is connected to a machine or tool. An adjustment path 13 is defined in communication between the inlet path 11 and the outlet path 12, and a communication path 14 is defined in communication between the outlet path and the adjustment path 13.

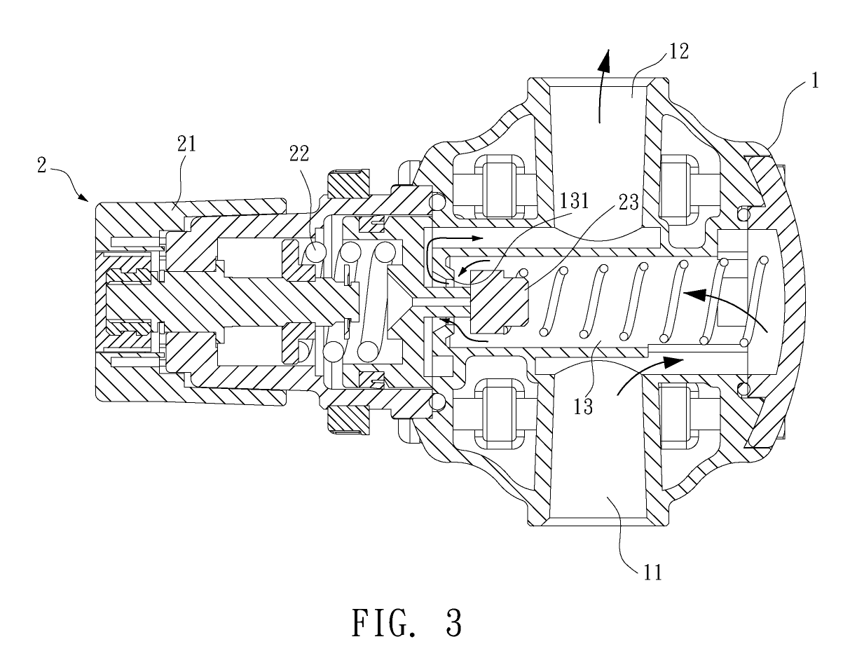

As shown in FIGS. 1 and 3, the adjustment valve 2 includes a knob 21 which is rotatable to control a spring 22 in the body 1 so as to move a block 23 in the adjustment path 13 toward a passage 131 of the adjustment path 13. When the pressure of the input pressurized air is smaller than the force of the spring 22, the pressurized air passes through the adjustment valve 2. When the pressure of the input pressurized air is larger than the force of the spring 22, the block 23 is moved toward the passage 131 of the adjustment path 13 and blocks the passage 131 so keep the pressurized air output from the output path 12 at a certain value.

The display unit 3 includes a pressure detection member 31 and a rotary part 32 which is connected to the body 1. A space 4 is sealed and defined between the body 1 and the rotary part 32. The space 4 communicates with the communication path 14 and the pressure detection member 31 is located in the space 4. A display screen 33 is located on the rotary part 32 and electrically connected to the pressure detection member 31, so that the display screen 33 can be rotated by rotating the rotary part 32.

In the embodiment of the present invention, the display unit 3 includes a lock ring 34 which has a through hole 341 defined centrally therethrough, and the body 1 includes a peripheral wall 15 and a chamber 16 is enclosed by the peripheral wall 15. The chamber 16 communicates with the communication path 14. The rotary part 32 together with the pressure detection member 31 are located in the chamber 16. The rotary part 32 is engaged with the through hole 341. The lock ring 34 includes top lip 342 extends inward from an open top of the through hole 341 and the rotary part 32 includes a flange 321 extending outward therefrom. The lock ring 34 is securely mounted to the peripheral wall 15 of the body 1 and the top lip 342 presses on the flange 321 which presses on the peripheral wall 15.

A reception recess 161 is defined in the chamber 16 and a filtering member 5, such as an oil-absorbing cotton, is received in the reception recess 161. The plate 6 is co-rotatable with the rotary part 32. The communication path 14 communicates with the reception recess 161 and the plate 16 includes an aperture 61 from which the pressure detection member 31 detects pressure. In order to seal the chamber 6, a seal ring 7 is located between the peripheral wall 15 of the body 1 and the flange 321 of the rotary part 32. Another seal ring 7 is located between the plate 6 and the chamber 16.

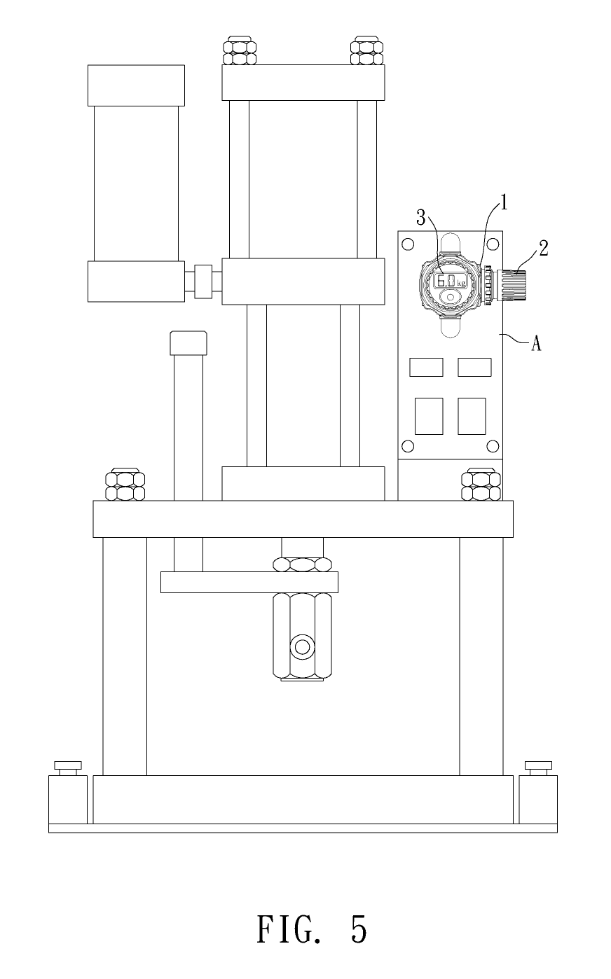

As shown in FIG. 5, the pressure detection device of the present invention is installed to a machine “A” such as a pressing machine, the knob 21 of the adjustment valve 2 is arranged to project toward a sufficient open space (right side of the machine) so that the user can easily access the knob 21. The display screen 33 is rotated by rotating the rotary part 32 so that the user can see the value of the pressure displayed in the display screen 33 conveniently.

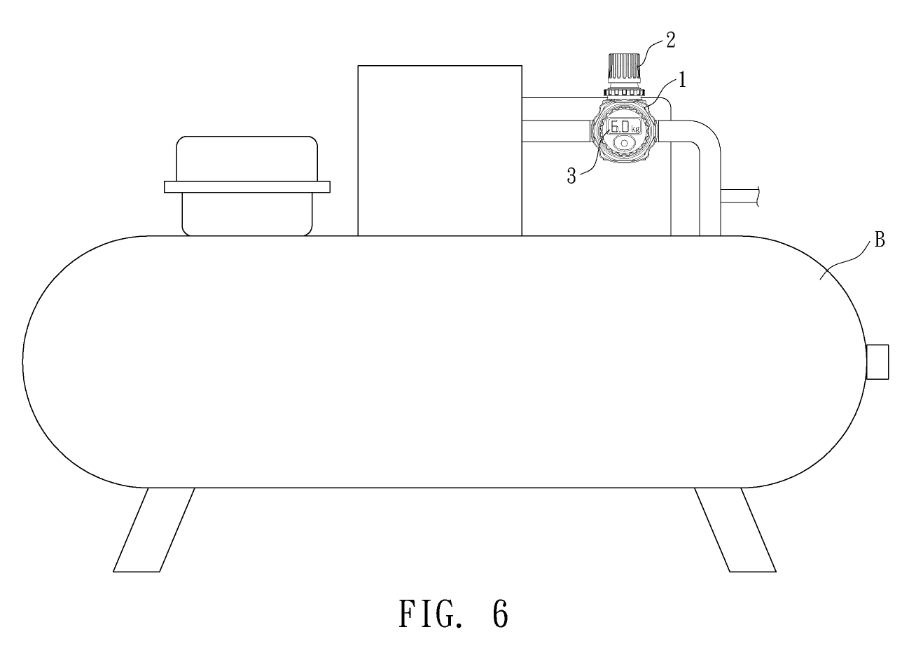

As shown in FIG. 6, the pressure detection device of the present invention is installed to a machine “B” such as a compressor, the knob 21 of the adjustment valve 2 is arranged to project toward top of the compressor so that the user can easily access the knob 21. The display screen 33 is rotated by rotating the rotary part 32 so that the user can see the value of the pressure displayed in the display screen 33 conveniently.

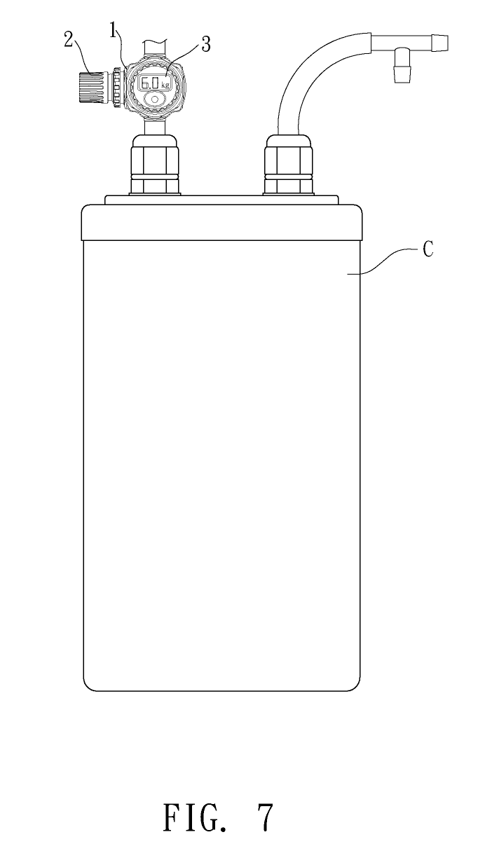

As shown in FIG. 7, the pressure detection device of the present invention is installed to a machine “C” such as a container, the knob 21 of the adjustment valve 2 is arranged to project toward left side of the machine “C” so that the user can easily access the knob 21. The display screen 33 is rotated by rotating the rotary part 32 so that the user can see the value of the pressure displayed in the display screen 33 conveniently.

The advantage of the present invention is easily revealed that after the pressure display device is installed, the display screen 33 can be adjusted by rotating the rotary part 32 to a proper orientation for convenience of observation, so that when the pressure display device is installed to a hydraulic tool or machine, the display screen 33 can be adjusted its angle of view relative to the body 1. Accordingly, the installation of the pressure display unit of the present invention is not restricted as described for the conventional pressure display screen and the pressure display unit of the present invention can be adjusted according the need of the users. The pressure display unit of the present invention is easily installed and conveniently operated.

While we have shown and described the embodiment in accordance with the present invention, it should be clear to those skilled in the art that further embodiments may be made without departing from the scope of the present invention.

What is claimed is:

1. A pressure display device comprising:
a body having an adjustment valve connected thereto, an inlet path and an outlet path defined in the body and an adjustment path defined in communication between the inlet path and the outlet path, a communication path defined in communication between the outlet path and the adjustment path, and the display unit having a pressure detection member and a rotary part which is connected to the body, a space sealed and defined between the body and the rotary part, the space communicating with the communication path and the pressure detection member located in the space, a display screen located on the rotary part and electrically connected to the pressure detection member, the display screen being rotated by rotating the rotary part.

2. The device as claimed in claim 1, wherein the display unit includes a lock ring which has a through hole defined centrally therethrough, the body includes a peripheral wall and a chamber is enclosed by the peripheral wall, the chamber communicates with the communication path, the rotary part together with the pressure detection member are located in the chamber, the rotary part is engaged with the through hole.

3. The device as claimed in claim 2, wherein the lock ring includes top lip extending inward from an open top of the through hole and the rotary part includes a flange extending outward therefrom, the lock ring is securely mounted to the peripheral wall of the body and the top lip presses on the flange which presses on the peripheral wall.

4. The device as claimed in claim 2, wherein a reception recess is defined in the chamber and a filtering member is received in the reception recess, the plate is co-rotatable with the rotary part, the communication path communicates with the reception recess, the plate includes an aperture from which the pressure detection member detects pressure.

5. The device as claimed in claim 4, wherein the filtering member is an oil-absorbing cotton.

6. The device as claimed in claim 1, wherein a seal ring located between the peripheral wall of the body and the flange of the rotary part, another seal ring is located between the plate and the chamber.

7. The device as claimed in claim 1, wherein the adjustment valve and the display unit are connected to a hydraulic machine together with the body.
